(19) United States
(12) Patent Application Publication
(10) Pub. No.: US 2008/0035076 A1
(43) Pub. Date: Feb. 14, 2008

(54) Buoyant Animal Collar

(75) Inventor: Wayne Everett Waterfield, Mission (CA)

Correspondence Address: WAYNE EVERETT WATERFIELD, 8324 PEACOCK PLACE, MISSION, BC, V2V-7A1, US

(73) Assignee: WAYNE EVERETT WATERFIELD, MISSION (CA)

(21) Appl. No.: 11/464,205

(22) Filed: Aug. 14, 2006

(51) Int. Cl. A01K 27/00

(52) U.S. Cl. 119/856

(57) ABSTRACT

The “Buoyant Animal Collar” is essentially a flexible pad made from closed-cell foam that is wrapped around the neck of a dog or animal for providing additional buoyant support to the head of the dog or animal when the dog or animal is swimming while holding an object in the open mouth. The “Buoyant Animal Collar” assists in keeping a dog's lower jaw sufficiently above the surface of the water in order to reduce the amount of water that enters the dog's throat as the dog swims while holding an object in the open mouth. The “Buoyant Animal Collar” can be worn comfortably by a dog with minimal interference with the dog's natural swimming ability, is not restrictive to the dog's agility of movement on land, is not at risk of being rendered useless if punctured, is simple to apply to the dog, and is convenient for a person to carry.

### FIELD OF THE INVENTION

This invention relates to a collar that provides additional buoyant support to the head of a dog or animal when the dog or animal is holding an object in the open mouth while swimming or afloat in a body of water, in order to assist the dog or animal in keeping the lower jaw sufficiently above the surface of the water to minimize the amount of water that enters the dog's throat.

### BACKGROUND OF THE INVENTION

It has been observed that many people have their dogs accompany them when enjoying recreational activities in, on, or at a body of water. Many, if not the majority of the people present at the body of water throw balls, sticks, or other objects into the water for their dogs to swim out into the water and retrieve the floating objects.

It has been observed that many dogs can actually be heard to gag from water entering their throat when swimming while holding an object in their open mouth. This observation appears to indicate that it is more difficult for dogs to keep their lower jaw sufficiently above the surface of the water when swimming while holding an object in their open mouth.

Although existing animal flotation devices such as life vests assist in keeping a dog's head above water, and consequently also help to keep the dog's lower jaw above water, these devices may actually interfere with the dog's natural swimming ability, especially when the dog is focused on retrieving an object in the water as quickly as possible. Furthermore, life vests can be restrictive to the dog's agility of movement on land, can be difficult for a person to apply to the dog, and may be a burden for a person to carry when the life vest is not being worn by the dog. Furthermore, a life vest is not appropriate when a person does not require or desire a life preservation device to be worn by the dog.

There is a need for a device that assists in keeping a dog's lower jaw sufficiently above the surface of the water in order to minimize the amount of water that enters the dog's throat when the dog is swimming while holding an object in the open mouth.

There is a need for a device that assists in keeping a dog's lower jaw sufficiently above the surface of the water in order to minimize the amount of water that enters the dog's throat when the dog is swimming while holding an object in the open mouth, that causes minimal interference with the dog's natural swimming ability and is not restrictive to the dog's agility of movement on land.

There is a need for a device that assists in keeping a dog's lower jaw sufficiently above the surface of the water in order to minimize the amount of water that enters the dog's throat when the dog is swimming while holding an object in the open mouth, that is convenient for a person to transport and is simple to apply to the dog.

Also, there is a need for a device that assists in keeping a dog's lower jaw sufficiently above the surface of the water in order to minimize the amount of water that enters the dog's throat when the dog is swimming while holding an object in the open mouth, that is not at risk of being rendered useless if the device is punctured.

The “Buoyant Animal Collar”, herein described, can be worn comfortably by a dog with minimal interference with the dog's natural swimming ability, is not restrictive to the dog's agility of movement on land, is not at risk of being rendered useless if punctured, is simple to apply to the dog, and is convenient for a person to carry. When worn around the neck of a dog, the “Buoyant Animal Collar” provides additional buoyant support to the dog's head when the dog is swimming while holding an object in the open mouth, in order to assist in keeping the dog's lower jaw sufficiently above the surface of the water to reduce the amount of water that enters the dog's throat.

### BRIEF SUMMARY OF THE INVENTION

The present invention in its simplest form is a flexible pad composed of inherently buoyant foam material which is configured into a collar for providing additional buoyant support to the head of a dog or animal when the dog or animal is in a body of water. The pad of the present invention is formed from a strip of flexible, closed-cell foam material.

It is preferred that the pad is composed of NBR/PVC foam. NBR/PVC is a common industrial foam composed of a blend of Acrylonitrile-Butadiene Rubber (NBR) and Polyvinyl Chloride (PVC). NBR/PVC foam is buoyant, flexible, soft, non-absorbent, and is resistant to oils and temperature extremes.

It is preferred that the pad be substantially rectangular in shape. The pad has a length of sufficient size such that when the pad is wrapped around the animal's neck, the ends of the pad sufficiently overlap to allow for fastening together.

The pad has a width of sufficient size such that when wrapped around the animal's neck, the pad maximizes coverage between the animal's mandible and scapula without exceeding a width that limits movement of the animal's head.

The pad has a thickness of a size that may extend to but not surpass the end of the animal's mandible when wrapped around the animal's neck; does not exceed a thickness of a size that limits movement of the animal's head when the pad is wrapped around the animal's neck; and does not exceed a thickness of a size that prevents the pad from being easily wrapped and secured around the animal's neck.

It is preferred that the pad be tapered at each end such that the thickness at each end is approximately ½ of the thickness of that at the middle of the pad. Thus, when the collar is wrapped around the animal's neck, the combined thickness of the overlapping portion of the pad is reduced thereby maintaining a more consistent thickness of buoyant foam encircling the neck of the animal.

It is preferred that each end of the pad be substantially semicircular to increase hydrodynamic performance of the collar when moving through the water.

It is preferred that the entire surface of the pad be coated or encased with a waterproof covering such as vinyl to increase hydrodynamic performance of the collar, allow the collar to be more easily maintained in a state of cleanliness, and for the collar to appear more aesthetically pleasing.

As an alternative to vinyl, the pad may be coated or encased with a waterproof covering that is light-reflective, to give the collar the added benefit of night visibility.

It is also preferred that hook and loop fastener material be used as the means for securing the pad around the neck of the animal. At least one strip of hook material and one strip of loop material adhesively attached to the appropriate side of each end of the pad offers the simplest form of securing the pad around the animal's neck and also offers better hydrodynamic performance relative to other forms of fastening means such as straps and buckles. The use of other forms of fastening means such as straps and buckles also increases the possibility of the collar becoming snagged onto an object and causing the collar to break away from the animal's neck or preventing the animal from moving freely.

Although a substantially rectangular pad is described here in constructing the preferred embodiment of the collar, it should be noted and understood that the pad could be configured into virtually an endless number of shapes without departing from the spirit of the invention. For example, the collar of the present invention constructed from a pad in the shape of a cylinder would offer substantially the same benefits as the collar of the present invention constructed from a rectangular pad when configured according to the specifications and limitations herein described.

### BRIEF DESCRIPTION OF THE SEVERAL VIEWS OF THE DRAWING

FIG. 1 is a plan view of the collar;

FIG. 2 is an elevation view of the collar;

FIG. 3 is a transverse cross-sectional view of the collar as taken in the direction of arrows 3-3 of FIG. 2;

FIG. 4 is a detail of the region 4 of FIG. 3; and

FIG. 5 is a perspective view of the collar illustrated about the neck of a dog.

### DETAILED DESCRIPTION OF THE INVENTION

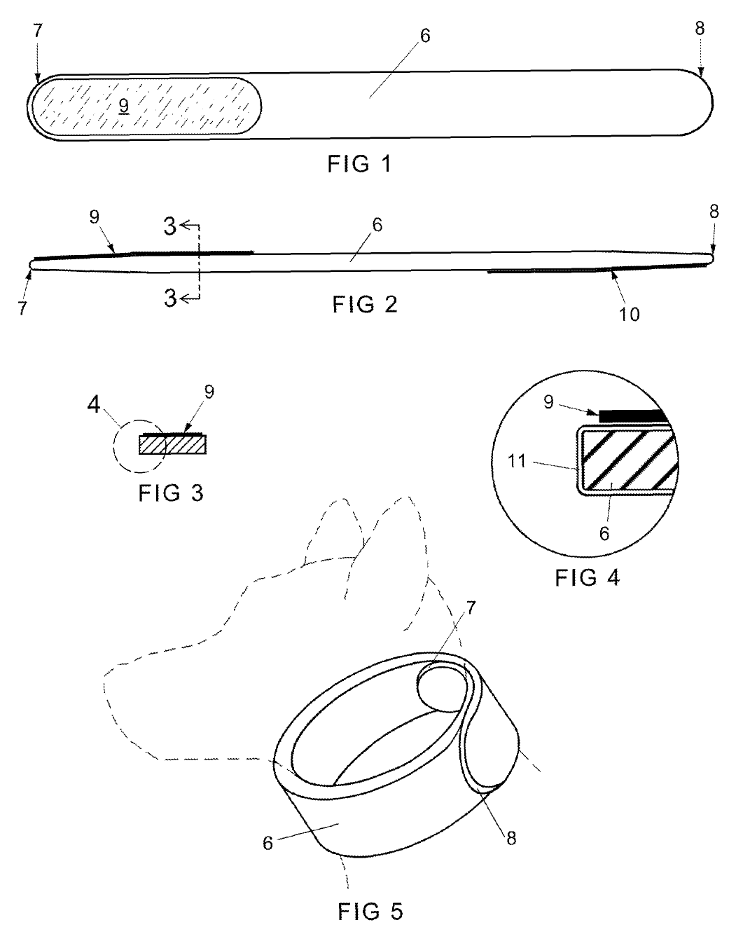

FIGS. 1-5 illustrate one embodiment of the present invention.

The collar is formed from a pad 6 of flexible, closed-cell foam material. NBR/PVC is the preferred foam material, which is a blend of Acrylonitrile-Butadiene Rubber (NBR) and Polyvinyl Chloride (PVC). The preferred average density of the NBR/PVC foam material is between 60 and 80 kg/m³.

It is preferred that the pad 6 be substantially rectangular and that the pad ends 7 and 8 be substantially semicircular for improved hydrodynamic performance (best illustrated in FIG. 1).

The pad 6 has a length of sufficient size such that when the pad 6 is wrapped around the animal's neck, the pad ends 7 and 8 sufficiently overlap to allow for fastening together (best illustrated in FIG. 5). The preferred distance that the pad ends 7 and 8 sufficiently overlap when the pad 6 is wrapped around the animal' neck is a distance equal to between ⅛ and ¼ of the length of the pad 6.

The pad 6 has a width of sufficient size that maximizes coverage between the animal's mandible and scapula without exceeding a width that limits movement of the animal's head when the pad 6 is wrapped around the animal's neck (best illustrated in FIG. 5).

The pad 6 has a thickness of a size that; may extend to but not surpass the end of the animal's mandible when wrapped around the animal's neck; does not exceed a thickness of a size that limits movement of the animal's head when the pad 6 is wrapped around the animal's neck; and does not exceed a thickness of a size that prevents the pad 6 from being easily wrapped and secured around the animal's neck. It is preferred that the ratio of the thickness of the pad 6 to the width of the pad 6 be not less than ¼ (best illustrated in FIG. 3).

It is preferred that the thickness of the pad 6 tapers down toward each of the pad ends 7 and 8 such that when the pad 6 is wrapped around the animal's neck, the combined thickness of the overlapping portion of the pad 6 is reduced. The preferred distance from each pad end 7 and 8 that the pad 6 begins to taper is a distance equal to between ⅛ and ¼ of the length of the pad 6. It is preferred that the pad ends 7 and 8 have a thickness approximately equal to ½ of the thickness of that at the middle of the pad 6 (best illustrated in FIG. 2).

The pad 6 is coated or encased with a waterproof covering 11 (best illustrated in FIG. 4 which is a detail of the region 4 of FIG. 3). It is preferred that the waterproof covering 11 be vinyl. The preferred method of applying the waterproof covering 11 of vinyl to the pad 6 is by dipping the pad 6 into liquid vinyl and manipulating the dipped pad 6 such that the vinyl cures to a substantially consistent thickness over the entire surface of the pad 6. The preferred thickness of the waterproof covering 11 is a thickness between 0.5 mm and 1.0 mm. An alternative to a waterproof covering 11 of vinyl is a waterproof covering 11 of light-reflective material to give the collar the added benefit of night visibility.

A substantially rectangular strip of hook material 9 is attached to one side of the pad 6 at the pad end 7. A strip of loop material 10, of identical size and shape to the strip of hook material 9, is attached to the opposite side of the pad 6 at the pad end 8 (best illustrated in FIGS. 1 and 2), such that when the pad 6 is wrapped around the animal's neck, the hook material 9 and the loop material 10 adhere to each other and the collar is thus secured around the animal's neck (best illustrated in FIG. 5). Both ends of the strip of hook material 9 and the strip of loop material 10 are shaped to match the shape of the pad ends 7 and 8, respectively (best illustrated in FIG. 1). The strip of hook material 9 and the strip of loop material 10 are located as close as possible to the pad ends 7 and 8, respectively, to ensure maximum adherence of the pad ends 7 and 8 when the pad 6 is wrapped around the animal's neck (best illustrated in FIG. 1). It is preferred that the length of the strip of hook material 9 and the strip of loop material 10 be of a size approximately equal to ⅓ of the length of the pad 6 in order to accommodate a multiplicity of neck sizes of animals (best illustrated in FIGS. 1 and 2). The preferred width of the strip of hook material 9 and the strip of loop material 10 is of a size that substantially spans the width of the pad 6 (best illustrated in FIGS. 1 and 3). A water-resistant adhesive glue of sufficient bonding properties is the preferred means of attaching the strip of hook material 9 and the strip of loop material 10 to the waterproof covering 11 encasing the pad 6.

While the novel features of the present invention have been described in terms of particular embodiments and preferred applications, it should be appreciated by one skilled in the art that substitution of materials and modification of details obviously can be made without departing from the spirit of the invention.

The embodiments of the invention in which an exclusive property or privilege is claimed are defined as follows:

1. A buoyant animal collar for providing additional buoyant support to the head of a dog or animal when the dog or animal is swimming or afloat in a body of water, comprising a collar consisting substantially of closed-cell foam material.

2. A buoyant animal collar for providing additional buoyant support to the head of a dog or animal when the dog or animal is swimming or afloat in a body of water, comprising
a pad of flexible, closed-cell foam material having a length of sufficient size to assure closure about the animal's neck, a width of a size not exceeding the distance between the animal's mandible and scapula, and a thickness of a size not exceeding the length of the animal's mandible; and
releasable fastening means for releasably fastening said pad of flexible, closed-cell foam material around the animal's neck.

3. The buoyant animal collar as defined in claim 2, wherein said pad of flexible, closed-cell foam material is coated or encased with a waterproof covering.

4. The buoyant animal collar as defined in claim 2, wherein said releasable fastening means comprises at least one strip of the hook portion and at least one strip of the loop portion of hook and loop fastener material attached to said pad of flexible, closed-cell foam material.

5. The buoyant animal collar as defined in claim 2, wherein said pad of flexible, closed-cell foam material is tapered such that the thickness of each end of said pad is substantially ½ of the thickness of that at the middle of said pad.

6. The buoyant animal collar as defined in claim 2, wherein said pad of flexible, closed-cell foam material consists substantially of NBR (Acrylonitrile-Butadiene Rubber) and PVC (Polyvinyl Chloride).

7. The buoyant animal collar as defined in claim 3, wherein said waterproof covering is vinyl.

8. The buoyant animal collar as defined in claim 3, wherein said waterproof covering is light-reflective material for the added benefit of night visibility.
